(19) United States
(12) Patent Application Publication
(10) Pub. No.: US 2025/0300391 A1
(43) Pub. Date: Sep. 25, 2025

(54) STRUCTURE FOR NETWORK CONNECTOR

(71) Applicants: Shao-chun WU, New Taipei (TW); Ling YU, Taipei (TW)

(72) Inventor: SHAO-CHUN WU, New Taipei (TW)

(21) Appl. No.: 18/661,869

(22) Filed: May 13, 2024

(30) Foreign Application Priority Data
Mar. 20, 2024 (TW) 113110326

(51) Int. Cl. H01R 13/502

(52) U.S. Cl. CPC H01R 13/502; H01R 2201/04

(57) ABSTRACT

An improved structure for a network connector comprises: a connecting member, having two ends, a height and a width; a first plate member, one side of which being connected with one end of the connecting member, the first plate member and the connecting member being perpendicularly connected with each other, and the first plate member having a height; a second plate member, one side of which being connected with another end of the connecting member, the second plate member and the connecting member being perpendicularly connected with each other, and the second plate member having a height; and a network connector, having plural single line storage slots, two sides of which being disposed at least one plate member fixing groove for disposing the first plate member or the second plate member, a distance between the two plate member fixing grooves being slightly equal to the width of the connecting member.

### CROSS-REFERENCE TO RELATED APPLICATIONS

This application claims priority to Taiwan Application Serial Number 113110326, filed Mar. 20, 2024, which is herein incorporated by reference in its entirety.

### BACKGROUND

### Technical Field

The present invention is in related to an improved structure for a connector, more particularly to an improved structure for a network connector.

### Related Art

The present network connector adopts a standard modularized connector, RJ45 (Registered Jack). When manufacturing a network cable in a normal way, part of the outer covering of the network cable will be removed, the plural twisted pairs in the network cable can be exposed out of the network cable. The twisted pairs are then disassembled, and then inserted into the single line storage slot of the network connector A1 in a predetermined order. Thereafter, through pressing the copper pins A11 of the single line storage slot of the network connector A1 toward the single line storage slot, so that the network cable is electrically connected with the copper pins A11, as shown in FIG. 5 and FIG. 5A, wherein FIG. 5A is a schematic cross-sectional view of AA in FIG. 5.

Following the above descriptions, regular and traditional network connectors can not easily determine the conditions of the plural twisted pairs in the network cable inserting into the single line storage slot after dismantling the plural twisted pairs. If the plural twisted pairs are not completely entered into the single line storage slots, and the copper pins A11 are then pushed into the single line storage slots, the condition of the network cable being not completely connected with the copper pins A11 happens, so that signal loss or intermittent signals may be caused. In addition, the indicated colors of the plural twisted pairs may be confused when in assembly. Therefore, the only way is to remove the network connector A1 to reproduce after crimp.

With reference to FIG. 6 and FIG. 6A, wherein FIG. 6 illustrates a schematic external view of another prior connecting member, and FIG. 6A illustrates a schematic cross-sectional view of BB in FIG. 6. For solving the above problem that the connecting condition of the plural twisted pairs cannot be determined, another type of network connector A2 is thus developed. The network connector A2 identically has a plurality of copper pins 21, and the only difference with aforesaid example is the network connector A2 further has a wire body auxiliary fixator A3. The wire body auxiliary fixator A3 also has a plurality of wire member fixing grooves A31 for fastening the plural twisted pairs. Each of the plural wire body auxiliary fixator A3 has an observation hole A311 in order to observe the condition of the twisted pair inserted into the wire member fixing groove A31. Continuously, the wire body auxiliary fixator A3 inserting into the network connector A2 can be affirmed after the plural twisted pairs being through the plural wire member fixing grooves A31. Then, when the wire body auxiliary fixator A3 is in the network connector A2 and close to the copper pins 21, to press the copper pins A21 is to make an electrical connection between the copper pins A21 and the twisted pairs.

However, as to the above example, the volume of the wire body auxiliary fixator A3 should be smaller than the network connector A2 for the network connector A2 accommodating the wire body auxiliary fixator A3. As it can be seen, if the wire body auxiliary fixator A3 is smaller, the difficulty of the twisted pairs entering into the wire body auxiliary fixator A3 will be highly raised in comparative. That is, construction will be very difficult as well.

Consequently, many different types of network connectors with installing methods are developed. With reference to FIG. 7, which illustrates a penetrating network connector A4. The plural twisted pairs of the network cable enter into a plurality of single line storage slots A41 of the network connector A4. Since the plurality of twisted pairs in the network cable protrude outside the network connector A4, during the crimping process, the construction personnel can easily determine the situation in which the twisted pairs enter the network connector A4, so that the success rate of crimping the network connector A4 increases. The single line storage slot A41 is a penetrating hole so as to let the twisted pair enter through and protrude outside the single line storage slot 41. That is, whether the arrangements of the plural twisted pairs can be determined for avoiding re-assembling. Next, a plurality of copper pins A42 are pressed toward the single line storage slots, and then the twisted pairs protruding out of the single line storage slots are cut off. However, the cut twisted pairs will have a plurality of exposed cut surfaces, which are exposed to the air through a plurality of openings of the single line receiving slots. The plurality of exposed cut surfaces of the twisted pairs will easily occur oxidation or short circuit, which will lead to the generation of noise, as shown in FIG. 8.

In regard to FIG. 8A, which illustrates a schematic cross-sectional view of the penetrating connecting member and the network cable in prior arts. As shown in figure, parts of the cut surfaces of the twisted pairs still protrude out of the network connector A4 after cutting, hence the cut surfaces exposed in the air may cause that the cut surfaces are electrically connected with non-specific conductive objects, that is, noise generation and data loose are continuous happening.

In order to improve the noise impact caused by the exposed cut surfaces of these twisted pairs, a cover member, correspondingly disposed on one side of the penetrating network connector, is developed to shelter the exposed cut surfaces of the twisted pairs in the market, such as the patent number M587379 of the Republic of China. The cover member achieves anti-static, anti-interference and anti-oxidation effects. On the other hand, the installation direction of the cover member is the same as the direction of the installation or dismantling of the penetrating network connector and the network equipment, and this will cause the cover member to easily loosen and separate from the penetrating network connector.

Therefore, how to overcome the noise problems encountered and ensure the stability of the connection, in order to let the present invention improve the production yield and the noise compared with the prior arts, it becomes a very important issue to people skilled in the art.

### SUMMARY

Accordingly, the objective of the present invention is to improve the production yield and the noise compared with the prior arts for figuring out the problems in prior arts.

An improved structure for a network connector comprises:
a connecting member, having two ends, a height and a width;
a first plate member, one side of the first plate member being connected with one end of the connecting member, the first plate member and the connecting member being perpendicularly connected with each other, and the first plate member having a height;
a second plate member, one side of the second plate member being connected with another end of the connecting member, the second plate member and the connecting member being perpendicularly connected with each other, and the second plate member having a height; and
a network connector, having a plurality of single line storage slots, two sides of the plurality of single line storage slots being disposed at least one plate member fixing groove, which is for disposing the first plate member or the second plate member, a distance between the two plate member fixing grooves being slightly equal to the width of the connecting member;
wherein the first plate member and the second plate member enter into the single line storage slots and the plate member fixing groove for being firmly disposed along a vertical direction.

In one embodiment, the heights of the first plate member and the second plate member are greater than or equal to the height of the connecting member.

In one embodiment, the first plate member and the second plate member are disposed an accommodation groove respectively.

In one embodiment, the plate member fixing groove is internally disposed a protruding portion, which is correspondingly arranged and fixed to the accommodation groove of the first plate member or the second plate member.

In one embodiment, the network connector is a penetrating network connector.

In one embodiment, the single line storage slot has two openings and a height.

In one embodiment, the network connector is used a network cable with plural twisted pairs to pass through, the network cable having two single lines, each of the two single lines penetrating through the single line storage slot of the network connector.

In one embodiment, the single line is provided with a cut surface, which is exposed at the opening of the single line storage slot of the network connector.

In one embodiment, the plate member fixing groove has a depth, which is greater than or equal to the height of the first plate member or the height of the second plate member.

The present invention adopts the technologies described as following. The plural twisted pairs of the network connector are inserted into the network connector 4. Each of the plural twisted pairs has two single lines, each of the two single lines penetrates through the single line storage slot 42 of the network connector 4, and then protrudes out from the single line storage slot 42. Thereafter, the residue part, of the single line, protruding out from the single line storage slot 42 is cut off to form the cut surface in order to let the cut surface of the single line be flush with and exposed at the opening 421 of the single line storage slot 42. The two sides of the network connector 4 are disposed two plate member fixing grooves 41, and the distance between the two plate member fixing grooves 41 is equal to the width w1 of the connecting member 1. Further, the depth d1 of the plate member fixing groove 41 is greater than or equal to the height h2 of the first plate member 2 or the height h3 of the second plate member 3. Accordingly, the first plate member 2 and the second plate member 3 can be disposed in the plate member fixing grooves 41 of the network connector 4, that is, the first plate member 2 and the second plate member 3 may not protrude out from the plate member fixing grooves 41. As a matter of fact, such structures avoid situations that would hinder installation and removal of existing specifications.

The height of the connecting member of the present invention is greater than or equal to the height of the single line storage slot, so that the connecting member is capable of totally covering the cut surfaces, of the single lines, that are exposed at the openings of the single line storage slots, in order to prevent that the single lines are exposed in the air for reducing or avoiding signal interference.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a schematic back view of a connecting member of the present invention;

FIG. 2 illustrates another schematic view of the connecting member of the present invention in another angle;

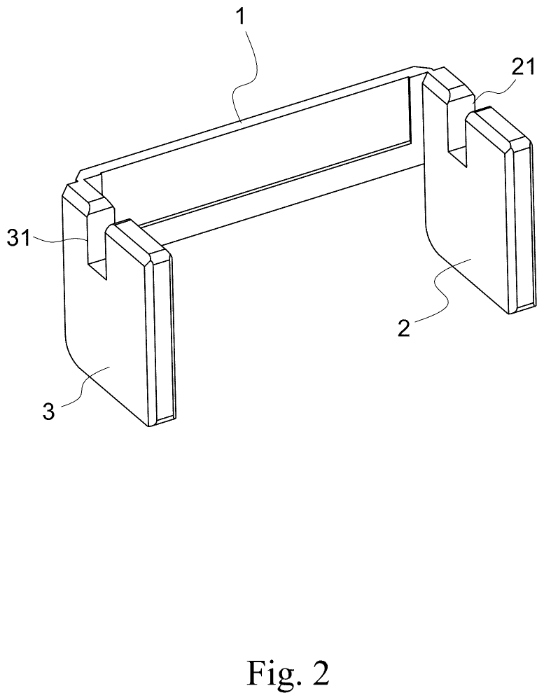

FIG. 3 illustrates a schematic exploded view of the connecting member and a network connector of the present invention;

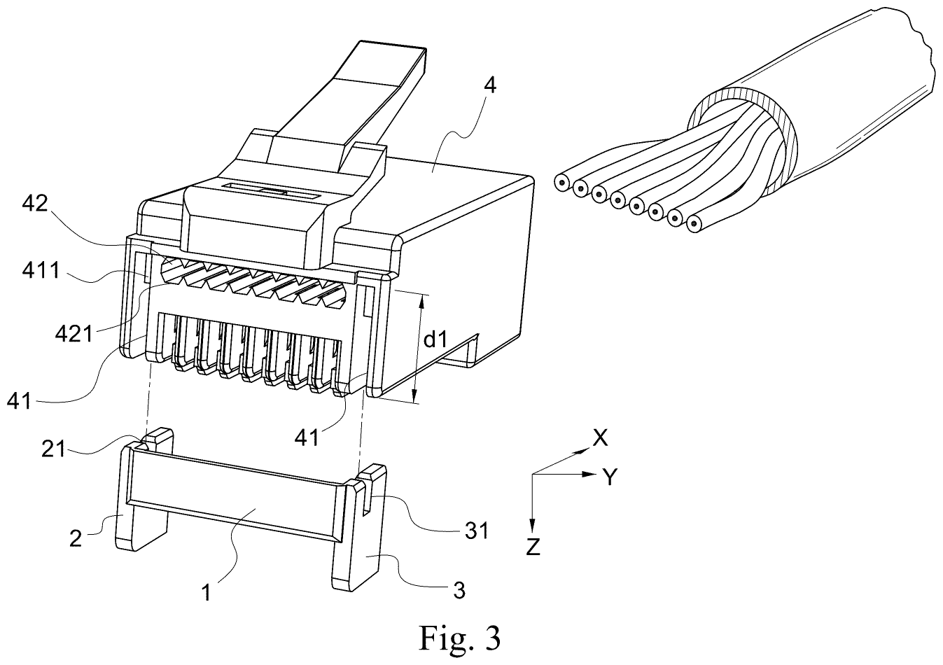

FIG. 4 illustrate a schematic assembly view of the connecting member and a network connector of the present invention;

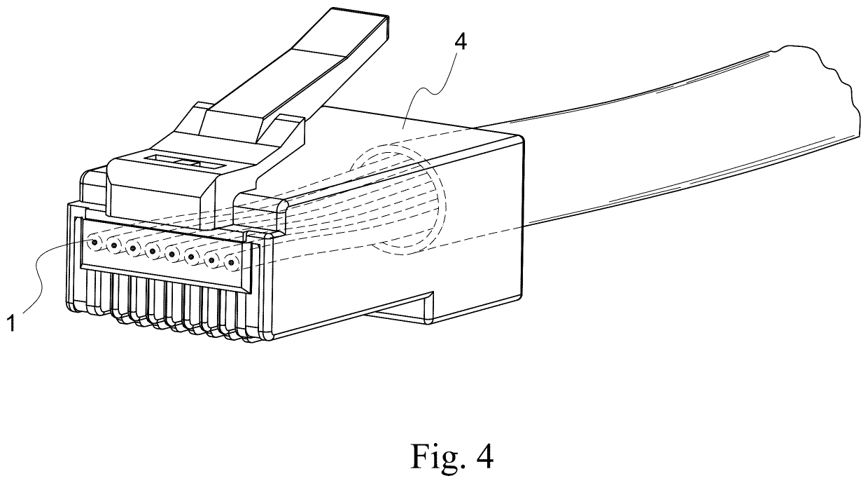

FIG. 5 illustrates a schematic appearance view of a connecting member in prior arts;

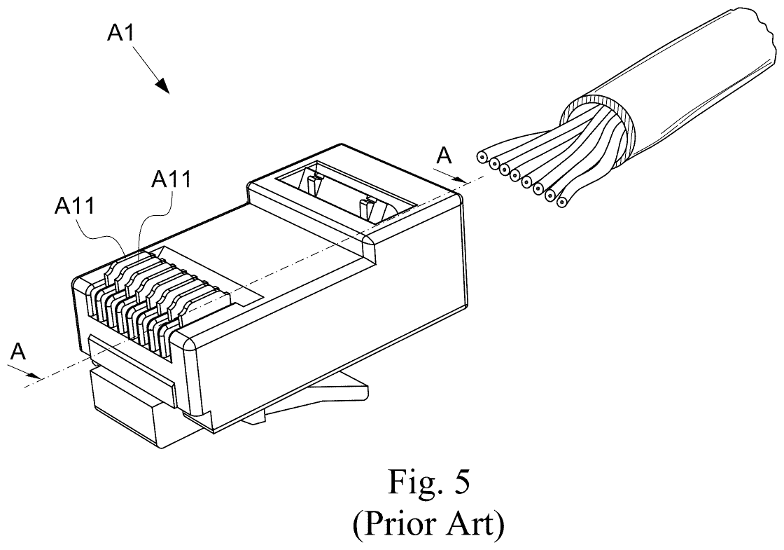

FIG. 5A illustrates a schematic cross-sectional view of AA in FIG. 5;

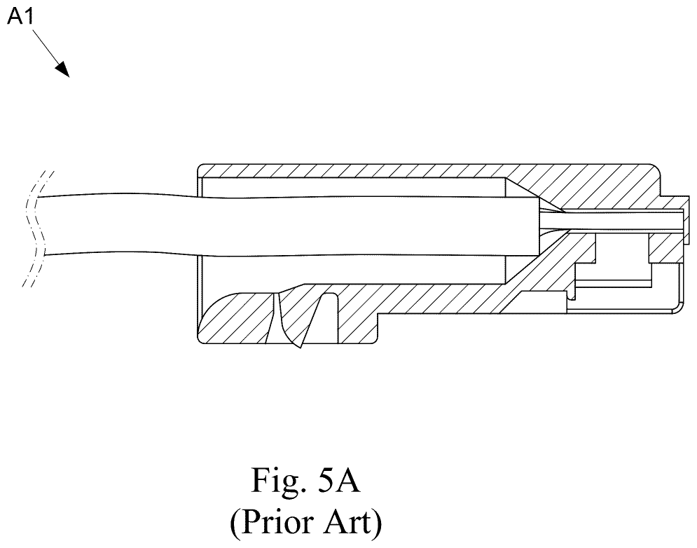

FIG. 6 illustrates a schematic appearance view of another connecting member in prior arts;

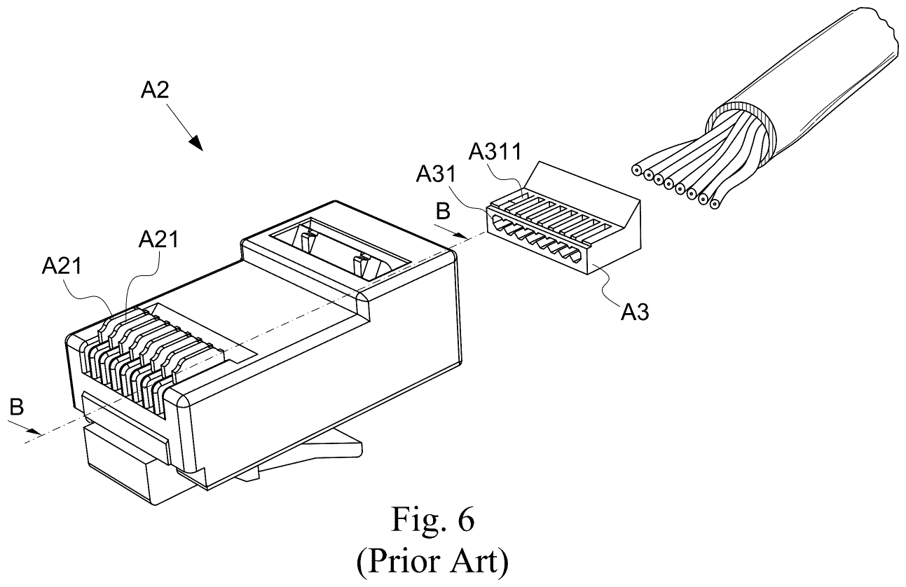

FIG. 6A illustrates a schematic cross-sectional view of BB in FIG. 6;

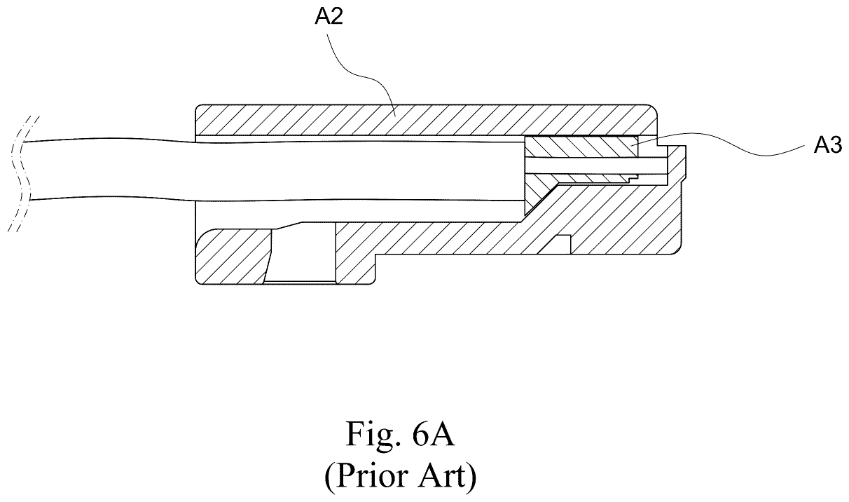

FIG. 7 illustrates a schematic appearance view of a protrusion of a network cable connected with a penetrating connecting member in prior arts;

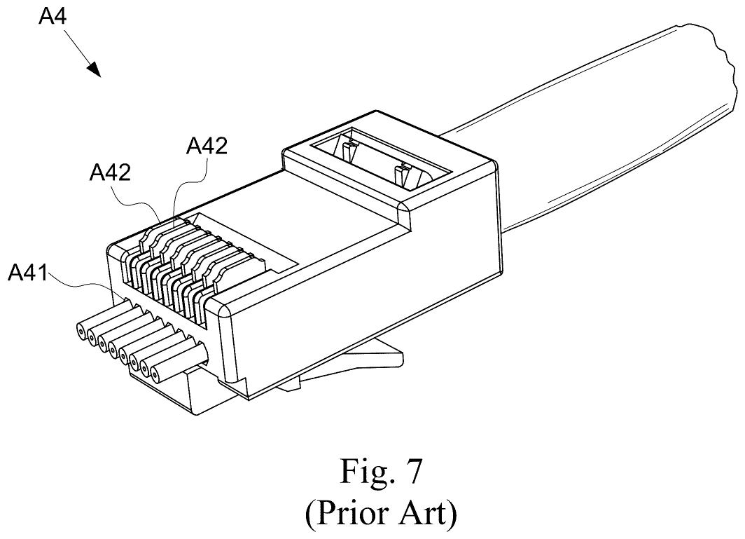

FIG. 8 illustrates a schematic appearance view of a cut of the network cable connected with the penetrating connecting member in prior arts; and

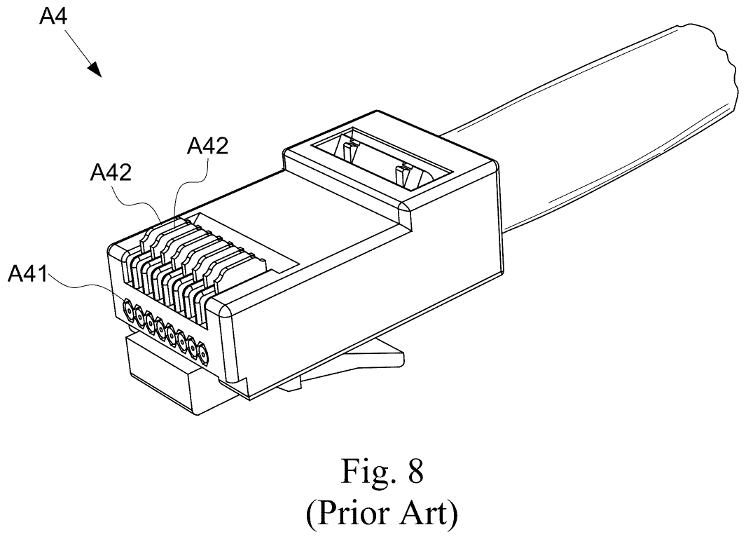

FIG. 8A illustrates a schematic cross-sectional view of the cut of the network cable connected with the penetrating connecting member in prior arts.

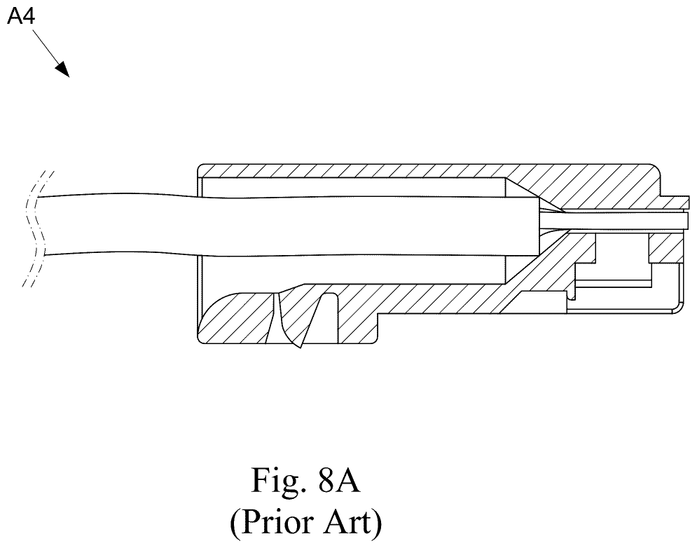

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

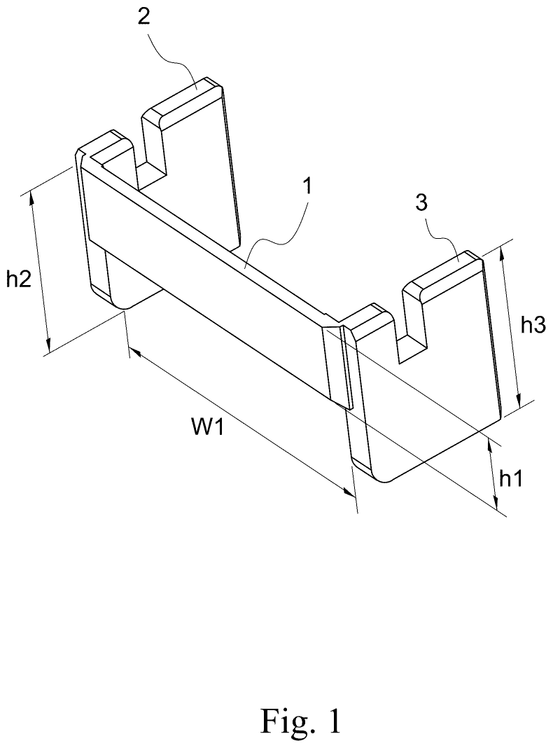

Please refer to FIG. 1, which illustrates a schematic back view of a connecting member of the present invention. The present invention discloses an improved structure for a network connector, and has a connecting member 1, a first plate member 2, a second plate member 3, and a network connector 4.

The connecting member 1 has two ends, a height h1 and a width w1. One end of the connecting member 1 is connected with one side of the first plate member 2, and another end of the connecting member 1 is connected with one side of the second plate member 3.

The first plate member 2 is perpendicularly connected with the connecting member 1, and the first plate member 2 has a height h2.

The second plate member 3 is perpendicularly connected with the connecting member 1, and the second plate member 3 has a height h3.

In the meantime, the first plate member 2 and the second plate member 3 are not connected with each other, and the arrangement directions of the first plate member 2 and the second plate member 3 are the same as the vertical direction of the connecting member 1.

The network connector 4 is a penetrating network connector, and further has at least one single line storage slot 42. Two sides of the single line storage slot 42 is further disposed at least plate member fixing groove 41. A distance between the two plate member fixing grooves 41 is slightly equal to the width w1 of the connecting member 1. Each of the single line storage slots 42 is a through hole, and two ends of the through hole has two openings 421. The two plate member fixing grooves 41 are for disposing the first plate member 2 and the second plate member 3. The first plate member 2 and the second plate member 3 enter into the single line storage slots 42 and the plate member fixing groove 41 for being firmly disposed along a vertical direction. The plate member fixing groove 41 has a depth d1, which is greater than or equal to the height h2 of the first plate member 2 or the height h3 of the second plate member (3). When the first plate member 2 or the second plate member 3 is accommodated in the plate member fixing groove 41, the condition of the first plate member 2 or the second plate member 3 protruding out of the plate member fixing groove 41 of the network connector 4 should be avoided.

As for an embodiment, the first plate member 2 and the second plate member 3 are disposed an accommodation groove 21, 31 respectively, and the plate member fixing groove 41 is internally disposed a protruding portion 411. In the case of the first plate member 2 or the second plate member 3 being disposed in the plate member fixing groove 41, the accommodation groove 21 of the first plate member 2 or the accommodation groove 31 of the second plate member 3 is combined with the protruding portion 411 of the plate member fixing groove 41. This is not to limit such structures, and the connecting member 1 and the network connector 4 are firmly assembled via such structures.

The network connector 4 further has a network line (not shown in figure), which is a network cable with plural twisted pairs, and each of the plural twisted pairs of the network cable has two single lines, each of the two single lines penetrates through the single line storage slot 42 of the network connector 4. In practice, the single line enters into the single line storage slot 42 via the opening 421, and goes out by means of the other opening 421. After the single line goes through the single line storage slot 42, the network connector 4 is thus crimped, so as to electrically connect a plurality of pins of the network connector 4 with the single line. Continuously, the residue part, of the single line, that protrudes out from the opening 421 will be cut off, a cut surface is then formed at one end of the single line. At last, the cut surface is made to flush with the opening 421 of the network connector 4.

The present invention adopts the technologies described as following. The plural twisted pairs of the network connector are inserted into the network connector 4. Each of the plural twisted pairs has two single lines, each of the two single lines penetrates through the single line storage slot 42 of the network connector 4, and then protrudes out from the single line storage slot 42. Thereafter, the residue part, of the single line, protruding out from the single line storage slot 42 is cut off to form the cut surface in order to let the cut surface of the single line be flush with and exposed at the opening 421 of the single line storage slot 42. The two sides of the network connector 4 are disposed two plate member fixing grooves 41, and the distance between the two plate member fixing grooves 41 is equal to the width w1 of the connecting member 1. Further, the depth d1 of the plate member fixing groove 41 is greater than or equal to the height h2 of the first plate member 2 or the height h3 of the second plate member 3. Accordingly, the first plate member 2 and the second plate member 3 can be disposed in the plate member fixing grooves 41 of the network connector 4, that is, the first plate member 2 and the second plate member 3 may not protrude out from the plate member fixing grooves 41. As a matter of fact, such structures avoid situations that would hinder installation and removal of existing specifications.

The single line storage slot 42 has a height, and the height h1 of the connecting member 1 of the present invention is greater than or equal to the height of the single line storage slot 42, so that the connecting member 1 is capable of totally covering the cut surfaces, of the single lines, that are exposed at the openings 421 of the single line storage slots 42, in order to prevent that the single lines are exposed in the air for reducing or avoiding signal interference.

Although the present disclosure is disclosed in the foregoing embodiments, it is not intended to limit the present disclosure. Changes and modifications made without departing from the spirit and scope of the present disclosure belong to the scope of the claims of the present disclosure. The scope of protection of the present disclosure should be construed based on the following claims.

What is claimed is:

1. An improved structure for a network connector comprising:
a connecting member (1), having two ends, a height (h1) and a width (w1);
a first plate member (2), one side of the first plate member (2) being connected with one end of the connecting member (1), the first plate member (2) and the connecting member (1) being perpendicularly connected with each other, and the first plate member (2) having a height (h2);
a second plate member (3), one side of the second plate member (3) being connected with another end of the connecting member (1), the second plate member (3) and the connecting member (1) being perpendicularly connected with each other, and the second plate member (3) having a height (h3); and
a network connector (4), having a plurality of single line storage slots (42), two sides of the plurality of single line storage slots (42) being disposed at least one plate member fixing groove (41), which is for disposing the first plate member (2) or the second plate member (3), a distance between the two plate member fixing grooves (41) being slightly equal to the width (w1) of the connecting member (1);
wherein the first plate member (2) and the second plate member (3) enter into the single line storage slots (42) and the plate member fixing groove (41) for being firmly disposed along a vertical direction.

2. The improved structure for the network connector according to claim 1, wherein the heights (h2), (h3) of the first plate member (2) and the second plate member (3) are greater than or equal to the height (h1) of the connecting member (1).

3. The improved structure for the network connector according to claim 3, wherein the first plate member (2) and the second plate member (3) are disposed an accommodation groove (21), (31) respectively.

4. The improved structure for the network connector according to claim 3, wherein the plate member fixing groove (41) is internally disposed a protruding portion (411), which is correspondingly arranged and fixed to the accommodation groove (21)/(31) of the first plate member (2) or the second plate member (3).

5. The improved structure for the network connector according to claim 1, wherein the network connector (4) is a penetrating network connector.

6. The improved structure for the network connector according to claim 1, wherein the single line storage slot (42) has two openings (421) and a height.

7. The improved structure for the network connector according to claim 6, wherein the network connector (4) is used a network cable with plural twisted pairs to pass through, the network cable having two single lines, each of the two single lines penetrating through the single line storage slot (42) of the network connector (4).

8. The improved structure for the network connector according to claim 7, wherein the single line is provided with a cut surface, which is exposed at the opening (421) of the single line storage slot (42) of the network connector (4).

9. The improved structure for the network connector according to claim 1, wherein the plate member fixing groove (41) has a depth (d1), which is greater than or equal to the height (h2) of the first plate member (2) or the height (h3) of the second plate member (3).
